(19) United States
(12) Patent Application Publication
(10) Pub. No.: US 2024/0262247 A1
(43) Pub. Date: Aug. 8, 2024

(54) SEAMLESS ELECTRICAL INTEGRATION OF SOLAR PANELS TO THE LOW-VOLTAGE ARCHITECTURE OF ANY EV

(71) Applicant: Lightyear Layer IPCo B.V., Helmond (NL)

(72) Inventor: Soumya BANDYOPADHYAY, Eindhoven (NL)

(21) Appl. No.: 18/570,232

(22) PCT Filed: Jun. 29, 2022
(86) PCT No.: PCT/EP2022/067887

§ 371 Date: Dec. 14, 2023

(30) Foreign Application Priority Data
Jun. 29, 2021 (NL) 2028562
Apr. 8, 2022 (NL) 2031534

(51) Int. Cl. B60L 58/20; B60L 1/00; B60L 50/60; H01M 10/0525; H01M 10/06; H01M 10/42; H02J 7/35; H02S 20/30; H02S 40/38

(52) U.S. Cl. CPC B60L 58/20; B60L 1/00; B60L 50/60; H01M 10/0525; H01M 10/06; H01M 10/425; H02J 7/35; H02S 20/30; H02S 40/38; B60L 2240/549; H01M 2220/20

(57) ABSTRACT

Power system for an electric vehicle comprising a high voltage bus connectable to a high voltage battery, a low voltage bus connectable to a low voltage battery, a first converter having a high voltage terminal configured to be connected to the high voltage bus, and a low voltage terminal configured to be connected to the low voltage bus, a second converter having a power terminal configured to be connected to a power source, and a low voltage terminal configured to be connected to the low voltage bus, a current sensor configured to determine an output current at the low voltage terminal of the first converter, a control unit controlling the second converter based on the determined output current, whereby the control unit is configured to control the second converter to supply a current to the low voltage bus so as to reduce the determined output current.

The present invention relates to the technical field of electrical vehicles. In particular the invention relates to a power system for an electric vehicle and a method of integrating a PV unit comprising at least one solar panel to an electric vehicle.

Electrification in the automotive industry is an increasing trend as a result of the increasing number and share of electric vehicles (EVs). For decades, vehicles with internal combustion engines were the technical standard. However, at the moment and in the coming years a serious turnaround takes place towards renewable energy sources.

Typically, EVs have a battery pack of, for example, Li-ion cells. The battery pack is connected to a high voltage bus, and one or more electric propulsion motors are powered from the high voltage bus. Such a means of transport also has a low voltage bus connected to auxiliary means, for example the internal lighting, the car audio system, airbags etc. The high voltage battery pack is often charged with a charger that connects the vehicle's high voltage bus with the grid. A high voltage (HV) to low voltage (LV) converter is used to power the low voltage bus from the high voltage bus or vice versa.

There are also EVs using solar panels comprising solar cells (photovoltaic cells) mounted on the vehicle to at least partly charge the vehicle. The solar panels are for example added to the roof, hood, tailgate and/or door panels of the EV. However, integrating the solar panels electrically to any EV is a challenging task as it either requires prior-knowledge of the control algorithm of the HV/LV converter or the HV system needs to be adapted. When the HV/LV converter is operating, it will have a voltage set-point. If that set-point voltage is known, the solar panels can be integrated to the LV bus with a DC/DC converter with a slightly higher voltage set-point than that of the HV/LV converter. There are three drawbacks of this architecture. First, the HV/LV set-point is not always known or not fixed. Secondly, if the HV/LV converter charges the LV battery, the terminal voltage of the LV battery blocks power coming from the solar panels. Thirdly, if there is no load on the LV bus, the solar panels dump the power into the LV battery of the EV. This leads to a higher number of charge cycles which reduces its lifetime. Due to these drawbacks, it is not feasible to integrate the solar panels to any EV without changing the control algorithm software of the HV/LV converter.

It is an object of the invention to provide an architecture for electrically integrating a power source to any EV wherein the above mentioned problems are solved, or at least to provide an alternative for known solutions.

The object of the invention is achieved with a power system for an electric vehicle comprising:
a high voltage bus for delivering energy to parts operating at a high voltage, wherein the high voltage bus is connectable to a high voltage battery,
a low voltage bus for delivering energy to auxiliary loads operating at a low voltage, wherein the low voltage bus is connectable to a low voltage battery,
a first converter having
   a high voltage terminal configured to be connected to the high voltage bus, and
   a low voltage terminal configured to be connected to the low voltage bus,
a second converter having
   a power terminal configured to be connected to a power source, and
   a low voltage terminal configured to be connected to the low voltage bus,
a control unit configured to
   receive a signal representative of an energy demand of the auxiliary loads, and
   control the second converter based on the received signal, whereby the control unit is configured to control the second converter to supply a current to the low voltage bus.

The invention thus relates to a power system for an electric vehicle. In an embodiment, the power system may comprise a power source or may be configured to be connected to a power source. In an embodiment, the power source may e.g. be a photovoltaic (PV) unit which comprises at least one solar panel. The electric vehicle (EV) may comprise one or more solar panels, e.g. mounted on the roof of the EV. Another example is that the power source is a hydrogen cell.

The power system comprises a high voltage bus and a low voltage bus. The high voltage bus is configured to deliver energy to parts operating at a high voltage, wherein the high voltage bus is connectable to a high voltage battery. High voltage is here used to indicate that the bus voltage exceeds the safe voltage limit, typically defined as 60 Vdc or 48 Vac. The low voltage bus operates at a safe voltage, typically 12 volts or 24 volts, although other voltages are known to be used. The low voltage bus is configured to deliver energy to auxiliary loads operating at a low voltage, wherein the low voltage bus is connectable to a low voltage battery. The auxiliary loads are for example the internal lighting of the EV, the car audio system, airbags etc. In an embodiment, the low voltage battery operates in a range of 12-48 volts, preferably 12 volts and the high voltage battery operates above 60 volts, preferably between 200-900 volts, more preferably between 300 volts and 430 volts. Electric vehicle battery voltages can go as high as 800-900 volts for current designs. In the future, higher voltages may be used as well.

The power system further comprises a first converter. The first converter has a high voltage terminal configured to be connected to the high voltage bus and a low voltage terminal configured to be connected to the low voltage bus. Typically, in EV applications, the first converter is a unidirectional DC/DC converter between the high voltage bus and the low voltage bus, mainly for generating a power flow from the high voltage bus to the low voltage bus. By doing so, the high voltage battery can e.g. supply the low voltage battery when the state of charge (SOC) of the low voltage battery becomes low and the auxiliary loads demand power. The first converter can also be a bidirectional converter.

Further, the power system comprises a second converter. The second converter has a power terminal configured to be connected to the power source and a low voltage terminal configured to be connected to the low voltage bus. The second converter is a multi-port converter, for example a two-port or three-port DC/DC converter. The second converter enables a power flow from the power source, e.g. a PV unit or a hydrogen cell, to the low voltage bus. The second converter is controllable by a control unit. The control unit is configured to receive a signal representative of an energy demand of the auxiliary loads. The control unit is configured to control the second converter based on the received signal to supply a current to the low voltage bus.

The signal indicates if at least one auxiliary load demands energy. If this is the case, the control unit controls the second converter to be switched on, whereby the second converter enables the power flow from the power source to the low voltage bus. In this way, the at least one auxiliary load is enabled to consume power originating from the power source. Hence, by controlling the second converter based on the signal the transfer of energy through the second converter is only enabled when this is required or when this is allowed. The transfer of power via the second converter to the low voltage bus has to be avoided when there is no energy demand from the auxiliary loads, because this poses the risk that a fully charged low voltage battery becomes overloaded. The vehicle consumes less energy from other sources, e.g. the low voltage battery or the high voltage battery.

Optionally, the charging level of the low voltage battery is monitored. In case there is no energy demand from the auxiliary loads and the low voltage battery is not fully charged, the generated power from the solar panels is supplied via the second converter to the low voltage battery to charge up the low voltage battery. For example, the second converter is enabled by the control unit such that a certain charging level of the low voltage battery, e.g. 80%, is reached.

As an example, suppose that the vehicle is stationary parked. In case that the driver turns on an auxiliary load, for example the alarm of the vehicle, a door lock etc., the respective auxiliary load requires power causing the signal to be generated. As a result, in response to the signal, the control unit controls the second converter to supply the current to the low voltage bus.

Additionally or in an another embodiment, the control unit receives the signal if the vehicle is unlocked. In such case the signal can thus be considered a signal representing an unlocking of the vehicle. The signal is for example an unlocking signal. In this embodiment, the signal represents a type of wake-signal of the vehicle. If the vehicle is unlocked, the control unit controls the second converter to supply the current to the low voltage bus to make sure that energy is transferred to the auxiliary loads demanding power as response to the unlocking action. For example, unlocking of the vehicle causes an HVAC system starting to operate, that the board computer is turned on, that external and/or internal lights are switched on, that the trunk of the vehicle is automatically opened etc. For example, the vehicle is unlocked with a key, e.g. a smartphone, which unlocks a door of the vehicle, e.g. the door is unlocked when the key is near the door wherein the user has the key with him, e.g. in his pocket (keyless entry). For example, the vehicle is remotely unlocked, e.g. by a smartphone.

Additionally or in an another embodiment, the vehicle comprises an external charging unit. Irrespective of the locked or unlocked state of the vehicle, the external charging unit can be used to charge a portable device, such as a smartphone. At the moment the external charging unit is used, the control unit receives the signal to control the second converter to supply the current to the low voltage bus. As a consequence, the external charging unit is charged by the supplied current.

Additionally or in an another embodiment, the control unit receives the signal if the vehicle is started. In such case the signal can thus be considered a signal representing a starting of the vehicle. The signal is for example a start-engine signal or an ignition signal. For example, the vehicle is started by turning the key in the ignition. For example, the vehicle is started by pressing a start-button in presence of the key, i.e. the so called keyless start. Starting the vehicle may cause that auxiliary loads require energy. For example, the HVAC system starts to operate, external and/or internal lights are switched on, audio system starts to play, etc.

In an embodiment, the power system according to the invention comprises a current sensor arranged at the low voltage terminal of the first converter. The current sensor is configured to determine an output current at the low voltage terminal of the first converter. For example, when the auxiliary loads are demanding power, the auxiliary loads may be supplied with power by the first converter. This current is determined by the current sensor. For example, the current sensor may be a clamp sensor or a hall effect sensor, e.g. a split core hall effect sensor. In an embodiment, the current sensor is configured to operate at a bandwidth of at least 1 kHz, preferably above 1 kHz, more preferably above 2 kHz.

Based on the determined output current of the first converter the control unit is configured to control the second converter, wherein the control unit controls the second converter to supply a current to the low voltage bus so as to reduce the determined output current. For example, the output current of the first converter is reduced below 0.5 A, preferably below 0.2 A, more preferably to 0 A, when the current sensor determines the output current at the low voltage terminal of the first converter. When the first converter is operating, the first converter will have a voltage set-point at the low voltage terminal, e.g. 14 V. In general, the voltage set-point is dynamic. By determining the output current of the first converter and by controlling the current flow of the second converter, the control unit indirectly controls the first converter, i.e. the power supplied by the first converter to the low voltage bus. The control unit can e.g. control the second converter to supply a current to the low voltage bus, e.g. by applying a dynamic voltage set-point. The control unit can e.g. control the second converter e.g. by transmitting a control signal to the second converter, the control signal being based on the detected output current. By supplying a current to the low voltage bus, and assuming that the power demand of the auxiliary loads is not altered, the output current of the first converter will reduce. To the first converter, it would seem that the power demand has diminished. By controlling the output power or current of the second converter based on the output current of the first converter, the power system according to the invention can be integrated without in depth knowledge about the operation of the first converter. Thus, independent of the first converter voltage set-point or without the (prior) knowledge of the first converter control algorithm, the power system enables the power source integration to the existing low voltage architecture of any EV.

In an embodiment, the power system further comprises an additional battery arranged at a battery terminal of the second converter. The additional battery may be configured to be charged or to store power generated by the power source, e.g. a PV unit or a hydrogen cell. The additional battery may e.g. be referred to as a solar battery which is configured to store solar power from a PV unit comprising at least one solar panel. The additional battery may e.g. be a Li-ion battery. The control unit is configured to control a power flow of the second converter from the power source and/or the additional battery to the low voltage bus. Imagine that the power source is generating power and the auxiliary loads do not require power (i.e. there is no load on the low voltage bus). The control unit may control the second converter, e.g. by transmitting a control signal to the second converter, such that the generated power flows only to the additional battery. The control signal triggers the second converter such that the voltage set-point at the low voltage terminal of the second converter is lower than the voltage set-point at the low voltage terminal of the first converter. Consequently, no current from the power source flows via the low voltage bus to the low voltage battery. An advantage is that the number of charging cycles of the low voltage battery can be reduced, wherein the lifetime of the low voltage battery substantially is unaffected.

In an embodiment, the power source is a PV unit comprising at least one solar panel and the additional battery is a solar battery. When the EV is parked in the shadow and the auxiliary loads are demanding power, e.g. the audio system is playing, the stored power in the solar battery is used to supply current to the low voltage bus. In an embodiment, the control unit is configured to supply the solar power generated by the at least one solar panel of the PV unit to the solar battery by controlling a solar power flow of the second converter from the PV unit to the solar battery. For example, when the EV is parked in the sun, the at least one solar panel is generating solar power. Supposing that the auxiliary loads are not consuming power, all generated solar power of the PV unit can be supplied via the second converter to the solar battery.

In an embodiment, the control unit comprises a hysteresis controller. The hysteresis controller is configured to control the current supply of the second converter. The hysteresis controller is configured to increase the current supply of the second converter to the low voltage bus when the determined output current at the low voltage terminal of the first converter becomes higher than a hysteresis range. Further, the hysteresis controller is configured to decrease the current supply of the second converter to the low voltage bus when the determined output current at the low voltage terminal of the first converter becomes lower than the hysteresis range.

The difference between the outer ranges of the hysteresis range, i.e. the minimum current value and the maximum current value, is defined as a hysteresis current swing. The hysteresis current swing will be fixed at a certain value depending on the resolution of the current sensor and current ripple, e.g. 1 A. However, based on the auxiliary load demand in view of the available power from the power source combined with the additional battery, the lowest or minimum current value of the hysteresis range will be variable and decided by the hysteresis controller for optimal performance. For example, when the load demand of the auxiliary loads is rather low, then the hysteresis range may e.g. be between 0.5 A to 1.5 A. However, if the load demand is high and the additional battery is operating at its highest power output, the minimum current will approximately shift to the following range:

$$\\ {I}_{load} ( t ) - {I}_{batt , max} - {I}_{cs} ( t ) + 0.5 A$$

wherein:

$$\begin{matrix}\\ \\ \begin{matrix}{I}_{load} = the load demand of the auxiliary loads expressed in ampere \\ {I}_{batt , max} = the maximum current rating of the additional battery \\ {I}_{cs} = the current produced by the power source \\ t = time\end{matrix}\end{matrix}$$

As an example, suppose that the maximum current rating of the additional battery is 10 A, the power source is producing 5 A and the load demand is 20 A at a given moment. Then the hysteresis range of the hysteresis controller will be from 5.5 A to 6.5 A.

Alternatively, the control unit is turned on or off based on a load current. The load current is the combination of the output current at the low voltage terminal of the first converter and current supply of the second converter to the low voltage bus. The control unit is turned on when the load current becomes higher than a predetermined first threshold. The control unit is turned off when the load current becomes lower than a predetermined second threshold. The predetermined first threshold and second threshold are similar to the outer ranges of the hysteresis range.

The invention further relates to a method of integrating a power source to an electric vehicle, the electric vehicle comprising
a high voltage bus for delivering energy to parts operating at a high voltage, wherein the high voltage bus is connectable to a high voltage battery,
a low voltage bus for delivering energy to auxiliary loads operating at a low voltage, wherein the low voltage bus is connectable to a low voltage battery,
a first converter configured to connect the high voltage bus arranged at a high voltage terminal of the first converter to the low voltage bus arranged at a low voltage terminal of the first converter,
   the method comprising the steps of:
connecting a second converter to the low voltage bus, wherein the low voltage bus is arranged at a low voltage terminal of the second converter,
mounting the power source to the electric vehicle,
connecting the power source to a power terminal of the second converter,
providing a control unit configured to
   receive a signal representative of an energy demand of the auxiliary loads, and
   control the second converter based on the received signal, whereby the control unit is configured to control the second converter to supply a current to the low voltage bus.

The method according to the invention deals with the integration of a power source to an electric vehicle (EV). The power source may e.g. be a PV unit comprising at least one solar panel or a hydrogen cell. The EV is at least partly chargeable by the power source. The EV comprises a high voltage bus, a low voltage bus and a first converter. The high voltage bus delivers energy to parts operating at a high voltage, wherein the high voltage bus is connectable to a high voltage battery. The low voltage bus delivers energy to auxiliary loads operating at a low voltage, wherein the low voltage bus is connectable to a low voltage battery. Further, the first converter is configured to connect the high voltage bus arranged at a high voltage terminal of the first converter to the low voltage bus arranged at a low voltage terminal of the first converter. Typically, the first converter is a unidirectional DC/DC converter between the high voltage bus and the low voltage bus for generating a power flow from the high voltage bus to the low voltage bus. The first converter can also be a bidirectional converter.

The method according to the invention comprises the step of connecting a second converter to the low voltage bus, wherein the low voltage bus is arranged at a low voltage terminal of the second converter. The second converter is a multi-port DC/DC converter, for example a three-port DC/DC converter.

The next step of the method according to the invention is mounting the power source to the electric vehicle. For example, the power source is a PV unit comprising at least one solar panel. The at least one solar panel includes solar cells grouped into one or more modules. Typically, the at least one solar panel is mounted in or on the roof of the electric vehicle.

After mounting the power source to the EV, the power source is connected to a power terminal of the second converter. The second converter enables a power flow from the power source, e.g. a PV unit or a hydrogen cell, to the low voltage bus. For example, when the auxiliary loads demand power, the second converter may provide power from the power source to the low voltage bus.

In a further step of the method according to the invention, a control unit is provided. The control unit is configured to receive a signal representative of an energy demand of the auxiliary loads. The control unit controls the second converter based on the received signal, whereby the control unit is configured to control the second converter to supply a current to the low voltage bus.

The signal indicates if at least one auxiliary load demands energy. If this is the case, the control unit controls the second converter to be switched on, whereby the second converter enables the power flow from the power source to the low voltage bus. In this way, the at least one auxiliary load is enabled to consume power originating from the power source. Hence, by controlling the second converter based on the signal the transfer of energy through the second converter is only enabled when this is required or when this is allowed. The vehicle consumes less energy from other sources, e.g. the low voltage battery or the high voltage battery.

As an example, suppose that the vehicle is stationary parked. In case that the driver turns on an auxiliary load, for example the alarm of the vehicle, a door lock etc., the respective auxiliary load requires power causing the signal to be generated. As a result, in response to the signal, the control unit controls the second converter to supply the current to the low voltage bus.

Additionally or in an another embodiment, the control unit receives the signal if the vehicle is unlocked. In this embodiment, the signal represents a type of wake-signal of the vehicle. If the vehicle is unlocked, the control unit controls the second converter to supply the current to the low voltage bus to make sure that energy is transferred to the auxiliary loads demanding power as response to the unlocking action. For example, unlocking of the vehicle causes the HVAC system starting to operate, that external and/or internal lights are switched on, that the trunk of the vehicle is automatically opened etc. For example, the vehicle is unlocked with a key, e.g. a smartphone, which unlocks a door of the vehicle, e.g. the door is unlocked when the key is near the door wherein the user has the key with him, e.g. in his pocket (keyless entry). For example, the vehicle is remotely unlocked, e.g. by a smartphone.

Additionally or in an another embodiment, the vehicle comprises an external charging unit. Irrespective of the locked or unlocked state of the vehicle, the external charging unit can be used to charge a portable device, such as a smartphone. At the moment the external charging unit is used, the control unit receives the signal to control the second converter to supply the current to the low voltage bus. As a consequence, the external charging unit is charged by the supplied current.

Additionally or in an another embodiment, the control unit receives the signal if the vehicle is started. For example, the vehicle is started by turning the key in the ignition. For example, the vehicle is started by pressing a start-button in presence of the key, i.e. the so called keyless start. Starting the vehicle may cause that auxiliary loads require energy. For example, the HVAC system starts to operate, external and/or internal lights are switched on, audio system starts to play, etc.

In an embodiment, the method according to the invention further comprises the step of arranging a current sensor at the low voltage terminal of the first converter. The current sensor is configured to determine an output current at the low voltage terminal of the first converter. For example, the current sensor may be a clamp sensor or a hall effect sensor, e.g. a split core hall effect sensor. The current sensor is configured to operate at a bandwidth of at least 1 kHz, preferably above 1 kHz, more preferably above 2 kHz.

The control unit is configured to control the second converter based on the determined output current by the current sensor. The current sensor may e.g. transmit a current signal representing the determined output current to the control unit to control the second converter. The control unit controls the second converter to supply a current to the low voltage bus so as to reduce the determined output current. For example, the output current of the first converter is reduced below 0.5 A, preferably below 0.2 A, more preferably to 0 A, when the current sensor determines the output current at the low voltage terminal of the first converter.

The reduction of the output current at the low voltage terminal of the first converter enables the power source integration to the low voltage side of any EV without the prior knowledge of the EV specific first converter control algorithm. Therefore, no support from the EV manufacturer is needed.

In an embodiment, the method according to the invention further comprises the step of connecting an additional battery to a battery terminal of the second converter. The additional battery is configured to store power generated by the power source. The additional battery may be configured to store power generated by the power source, e.g. a PV unit or a hydrogen cell. The additional battery may e.g. be a solar battery which is configured to store solar power from a PV unit comprising at least one solar panel. The additional battery may e.g. be a Li-ion battery. The control unit is configured to control a power flow of the second converter from the power source and/or the additional battery to the low voltage bus.

The invention is described below with reference to the figures. These figures serve as examples to illustrate the invention, and will not be construed as limiting the scope of the claims. In the different figures, like feature are indicated by the like reference numerals.

### IN THE FIGURES

FIG. 1: Schematically illustrates a traditional architecture of a power system of an electric vehicle (EV);

FIG. 2: Schematically illustrates an embodiment of an architecture of a power system with a power source integration at the low voltage side;

FIG. 3: Schematically illustrates a first embodiment of a power system according to the invention;

FIG. 4: Schematically illustrates a second embodiment of a power system according to the invention,

FIG. 5: Schematically illustrates an embodiment of a flow diagram of the method according to the invention.

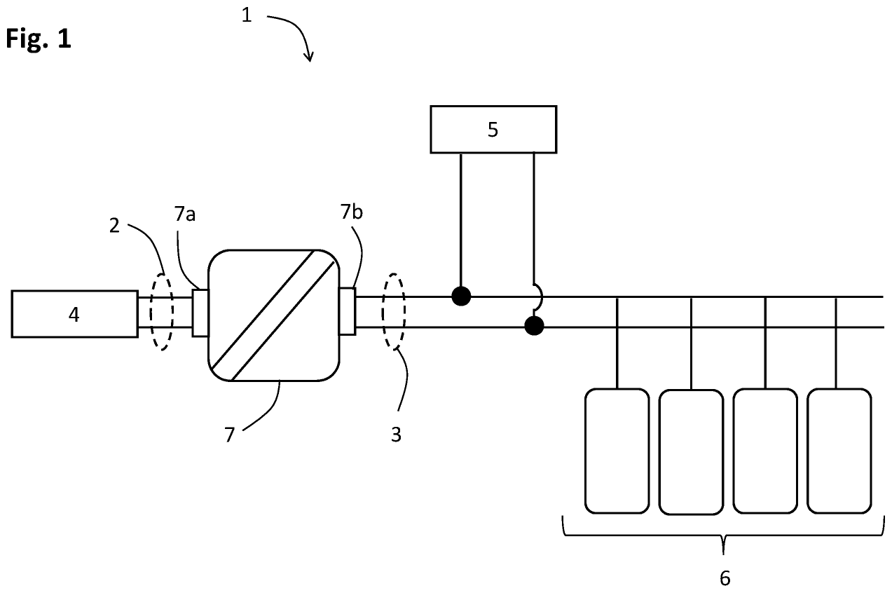

FIG. 1 illustrates a traditional architecture of a power system of an electric vehicle (EV). The power system 1 comprises a high voltage bus 2 and a low voltage bus 3. The high voltage bus 2 is connected to a high voltage battery 4. The high voltage bus 2 is configured to deliver energy from the high voltage battery 4 to parts operating at a high voltage. The high voltage battery 4 operates above 60 volts, preferably between 200-600 volts, more preferably between 300 volts and 450 volts. The low voltage bus 3 is connected to a low voltage battery 5. The low voltage bus 3 is configured to deliver energy from the low voltage battery 5 to auxiliary loads 6 operating at a low voltage. Hence, the auxiliary loads 6 are connected to the low voltage bus 3. In an embodiment, the low voltage battery 5 operates in a range of 12-48 volts, preferably 12 volts. For passenger cars, typically the low voltage battery is a 12 V lead acid battery. However, other types of batteries can be used as well, for example Li-based batteries.

In FIG. 1, the power system 1 further comprises a first converter 7. The first converter 7 has a high voltage terminal 7a connected to the high voltage bus 2 and a low voltage terminal 7b connected to the low voltage bus 3. The first converter 7 may be a unidirectional DC/DC converter for generating a power flow from the high voltage bus 2 to the low voltage bus 3. For example, the high voltage battery 4 may e.g. supply a current to the low voltage bus 3 via the first converter when the low voltage battery 5 is running out of charge and/or the auxiliary loads 6 require power.

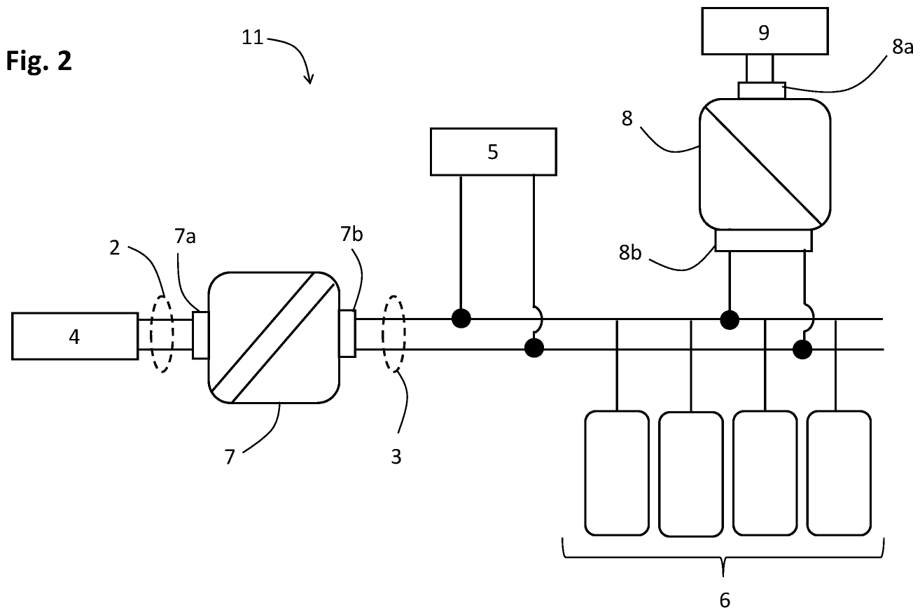

FIG. 2 shows an embodiment of an architecture of a power system 11 with a power source integration at the low voltage side. The other features of the power system 11 correspond with those of the power system 1 shown in FIG. 1, and therefore indicated with the same reference numerals in FIG. 2.

The power system 11 further comprises a second converter 8. The second converter 8 has a power terminal 8a configured to be connected to a power source 9 and a low voltage terminal 8b configured to be connected to the low voltage bus 3. The second converter 8 is a multi-port converter, for example a three-port DC/DC converter. The second converter 8 enables a power flow from the power source 9, e.g. a PV unit or a hydrogen cell, to the low voltage bus 3. The power source 9 for example comprises at least one solar panel and a maximum power point tracker (MPPT). The MPPT is for example an integral part of the second converter 8.

When the first converter 7 is operating, the first converter 7 will have a voltage set-point at the low voltage terminal 7b, e.g. 13.8 V. If that voltage set-point is known, the power source can be integrated to the low voltage bus 3 via the second converter 8 with a slightly higher voltage set-point, e.g. 14.4 V, than that of the first converter 7. However, the voltage set-point at the low voltage terminal 7b is not always known or not fixed. If the first converter 7 charges the low voltage battery 5, the voltage set-point at the low voltage terminal 7b increases, e.g. to 14.5 V-15 V, which blocks power coming from the power source 9. Therefore, with the architecture of a power system according to FIG. 2 it is not feasible to integrate the power source 9 to the EV without changing or knowing the control algorithm software of the first converter 7.

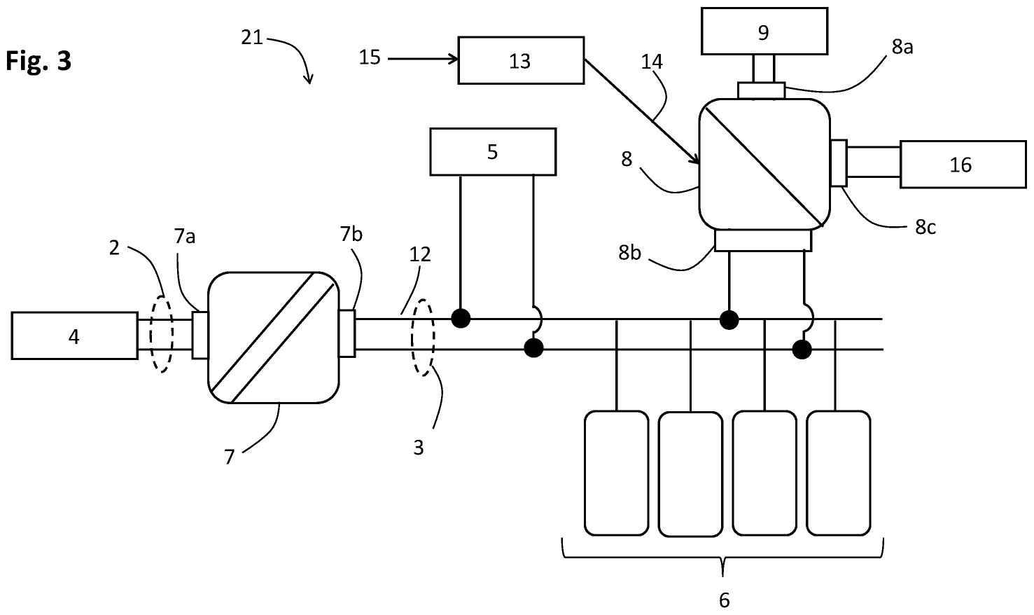

FIG. 3 shows a first embodiment of a power system 21 according to the invention. The other features of the power system 21 correspond with those of the power systems 1, 11 shown in FIGS. 1-2, and therefore indicated with the same reference numerals in FIG. 3.

The power system 21 according to the invention comprises a control unit 13. The control unit 13 receives a signal 15 representative of the energy demand of the auxiliary loads 6. Based on the signal 15, the control unit 13 controls the second converter 8, e.g. by transmitting a control signal 14 to the second converter 8, to supply a current to the low voltage bus 3.

The signal 15 indicates if at least one auxiliary load 6 demands energy. If this is the case, the control unit 13 controls the second converter 8 to be switched on, whereby the second converter 8 enables the power flow from the power source 9 to the low voltage bus 3. In this way, the at least one auxiliary load 6 is enabled to consume power originating from the power source 9. Hence, by controlling the second converter 8 based on the signal 15 the transfer of energy through the second converter 8 is only enabled when this is required or when this is allowed.

As an example, suppose that the vehicle is stationary parked. In case that the driver turns on an auxiliary load 6, for example the alarm of the vehicle, a door lock etc., the respective auxiliary load 6 requires power causing the signal 15 to be generated. As a result, in response to the signal 15, the control unit 13 controls the second converter 8 via control signal 14 to supply the current to the low voltage bus 3.

Additionally or in an another embodiment, the control unit 13 receives the signal 15 if the vehicle is unlocked. In this embodiment, the signal 15 represents a type of wake-signal of the vehicle. If the vehicle is unlocked, the control unit 13 controls the second converter 8 to supply the current to the low voltage bus 3 to make sure that energy is transferred to the auxiliary loads 6 demanding power as response to the unlocking action. For example, unlocking of the vehicle causes the HVAC system starting to operate, that external and/or internal lights are switched on, that the trunk of the vehicle is automatically opened etc. For example, the vehicle is unlocked with a key, e.g. a smartphone, which unlocks a door of the vehicle, e.g. the door is unlocked when the key is near the door wherein the user has the key with him, e.g. in his pocket (keyless entry). For example, the vehicle is remotely unlocked, e.g. by a smartphone.

Additionally or in an another embodiment, the vehicle comprises an external charging unit. Irrespective of the locked or unlocked state of the vehicle, the external charging unit can be used to charge a portable device, such as a smartphone. At the moment the external charging unit is used, the control unit 13 receives the signal 15 to control the second converter 8 to supply the current to the low voltage bus 3. As a consequence, the external charging unit is charged by the supplied current.

Additionally or in an another embodiment, the control unit 13 receives the signal 15 if the vehicle is started. For example, the vehicle is started by turning the key in the ignition. For example, the vehicle is started by pressing a start-button in presence of the key, i.e. the so called keyless start. Starting the vehicle may cause that auxiliary loads 6 require energy. For example, the HVAC system starts to operate, external and/or internal lights are switched on, audio system starts to play, etc.

The power system 21 further comprises an additional battery 16 arranged at a battery terminal 8c of the second converter 8. The additional battery 16 is configured to store power generated by the power source 9, e.g. a PV unit or a hydrogen cell. The additional battery 16 may e.g. be a solar battery which is configured to store solar power from a PV unit comprising at least one solar panel. The additional battery 16 may e.g. be a Li-ion battery. The control unit 13 is configured to control a power flow of the second converter 8 from power source 9 and/or the additional battery 16 to the low voltage bus 3. Imagine that the power source 9 is generating power and the auxiliary loads 6 do not require power (i.e. there is no load on the low voltage bus 3). The control unit 13 may control the second converter 8, e.g. by transmitting control signal 14 to the second converter 8, such that the generated power of the power source 9 flows only to the additional battery 16. The control signal 14 triggers the second converter 8 such that the voltage set-point at the low voltage terminal 8b of the second converter 8 is lower than the voltage set-point at the low voltage terminal 7b of the first converter 7. Consequently, no current from the power source 9 flows via the low voltage bus 3 to the low voltage battery 5. An advantage is that the number of charging cycles of the low voltage battery 5 can be reduced, wherein the lifetime of the low voltage battery 5 substantially is unaffected.

In an embodiment, the power source 9 is a PV unit comprising at least one solar panel and the additional battery 16 is a solar battery. When the EV is parked in the shadow and the auxiliary loads 6 are demanding power, e.g. the audio system is playing, the stored power in the solar battery 16 is used to supply current to the low voltage bus 3. In an embodiment, the control unit 13 is configured to supply the solar power generated by the at least one solar panel of the PV unit 9 to the solar battery 16 by controlling a solar power flow of the second converter 8 from the PV unit 9 to the solar battery 16. For example, when the EV is parked in the sun, the at least one solar panel is generating solar power. Supposing that the auxiliary loads 6 are not consuming power, all generated solar power of the PV unit 9 can be supplied via the second converter 8 to the solar battery 16.

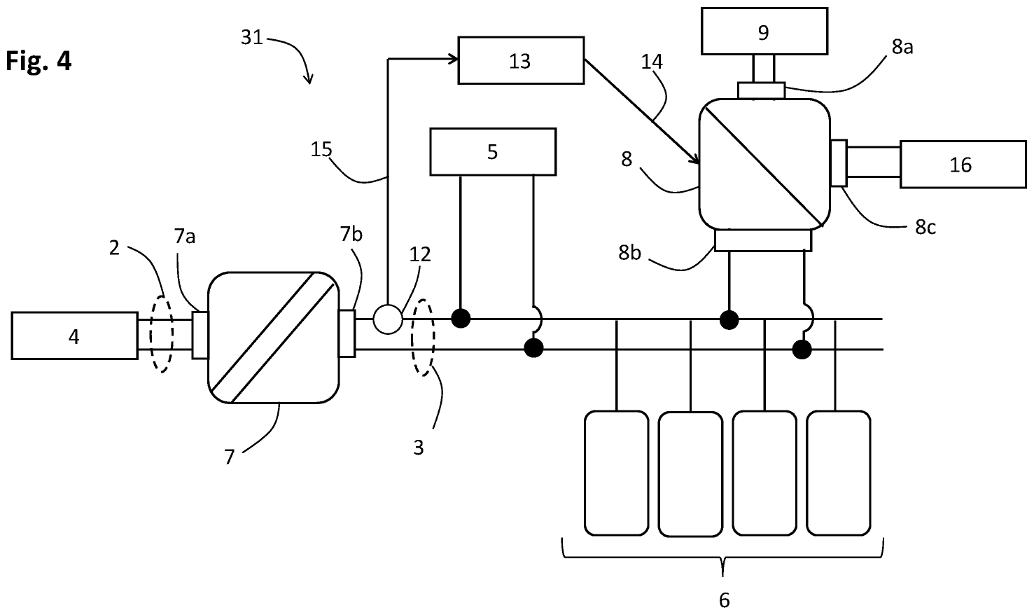

FIG. 4 shows a second embodiment of a power system 31 according to the invention. The other features of the power system 31 correspond with those of the power systems 1, 11, 21 shown in FIGS. 1-3, and therefore indicated with the same reference numerals in FIG. 4.

The power system 31 according to the invention comprises a current sensor 12 arranged at the low voltage terminal 7b of the first converter 7. The current sensor 12 determines an output current at the low voltage terminal 7b of the first converter 7. For example, when the auxiliary loads 6 are demanding power, the auxiliary loads 6 may be supplied with power via the low voltage bus 3 by the first converter 7. This current is determined by the current sensor 12. For example, the current sensor 12 may be a clamp sensor or a hall effect sensor, e.g. a split core hall effect sensor. The current sensor 12 is configured to operate at a bandwidth of at least 1 kHz, preferably above 1 kHz, more preferably above 2 kHz.

The control unit 13 controls the second converter 8, e.g. by transmitting control signal 14 to the second converter 8, to supply a current to the low voltage bus 3. The control signal 14 to the second converter 8 can be transmitted by the control unit 13 when there is a load on the low voltage bus 3, i.e. the auxiliary loads 6 are demanding power.

The current sensor 12 may e.g. transmit a current signal 15 representing the determined output current to the control unit 13 to control the second converter 8. Based on the determined output current by the current sensor 12, the control unit 13 controls the second converter 8 via the control signal 14 to supply a current to the low voltage bus 3 so as to reduce the determined output current. For example, the output current of the first converter is reduced below 0.5 A, preferably below 0.2 A, more preferably to 0 A, when the current sensor 12 determines the output current at the low voltage terminal 7b of the first converter 7.

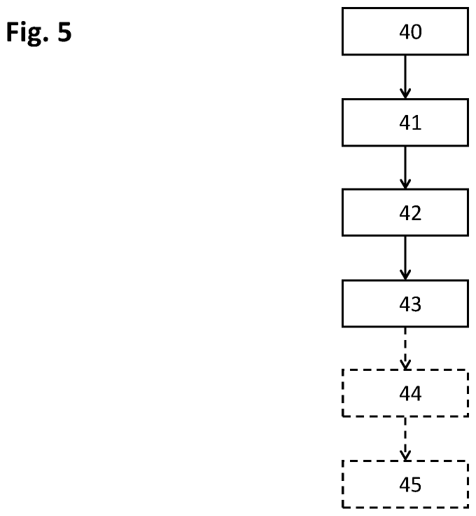

FIG. 5 schematically illustrates an embodiment of a flow diagram of the method according to the invention for integrating a power source to an electric vehicle. The electrical vehicle comprises a high voltage bus, a low voltage bus and a first converter. The high voltage bus is configured to deliver energy to parts operating at a high voltage, wherein the high voltage bus is connectable to a high voltage battery. The low voltage bus is configured to deliver energy to auxiliary loads operating at a low voltage, wherein the low voltage bus is connectable to a low voltage battery. The first converter is configured to connect the high voltage bus arranged at a high voltage terminal of the first converter to the low voltage bus arranged at a low voltage terminal of the first converter.

The method according to the invention comprises a first step 40 of connecting a second converter to the low voltage bus, wherein the low voltage bus is arranged at a low voltage terminal of the second converter. The second converter is a multi-port DC/DC converter, for example a three-port DC/DC converter.

The next step 41 of the method according to the invention is mounting the power source to the electric vehicle. For example, the power source is a PV unit comprising at least one solar panel. The at least one solar panel includes solar cells grouped in modules. Typically, the at least one solar panel is mounted in or on the roof of the electric vehicle.

After mounting the power source to the EV, the power source is connected to a power terminal of the second converter in a third step 42. The second converter enables a power flow from the power source, e.g. a PV unit or a hydrogen cell, to the low voltage bus. For example, when the auxiliary loads demand power, the second converter may provide power from the power source to the low voltage bus.

In a further step 43 of the method according to the invention, a control unit is provided. The control unit is configured to receive a signal representative of energy demand of the auxiliary loads. The control unit controls the second converter based on the received signal, whereby the control unit is configured to control the second converter to supply a current to the low voltage bus.

The signal indicates if at least one auxiliary load demands energy. If this is the case, the control unit controls the second converter to be switched on, whereby the second converter enables the power flow from the power source to the low voltage bus. In this way, the at least one auxiliary load is enabled to consume power originating from the power source. Hence, by controlling the second converter based on the signal the transfer of energy through the second converter is only enabled when this is required or when this is allowed.

As an example, suppose that the vehicle is stationary parked. In case that the driver turns on an auxiliary load, for example the alarm of the vehicle, a door lock etc., the respective auxiliary load requires power causing the signal to be generated. As a result, in response to the signal, the control unit controls the second converter to supply the current to the low voltage bus.

Additionally or in an another embodiment, the control unit receives the signal if the vehicle is unlocked. In such case the signal can thus be considered a signal representing an unlocking of the vehicle. The signal is for example an unlocking signal. In this embodiment, the signal represents a type of wake-signal of the vehicle. If the vehicle is unlocked, the control unit controls the second converter to supply the current to the low voltage bus to make sure that energy is transferred to the auxiliary loads demanding power as response to the unlocking action. For example, unlocking of the vehicle causes the HVAC system starting to operate, that external and/or internal lights are switched on, that the trunk of the vehicle is automatically opened etc. For example, the vehicle is unlocked with a key, e.g. a smartphone, which unlocks a door of the vehicle, e.g. the door is unlocked when the key is near the door wherein the user has the key with him, e.g. in his pocket (keyless entry). For example, the vehicle is remotely unlocked, e.g. by a smartphone.

Additionally or in an another embodiment, the vehicle comprises an external charging unit. Irrespective of the locked or unlocked state of the vehicle, the external charging unit can be used to charge a portable device, such as a smartphone. At the moment the external charging unit is used, the control unit receives the signal to control the second converter to supply the current to the low voltage bus. As a consequence, the external charging unit is charged by the supplied current.

Additionally or in an another embodiment, the control unit receives the signal if the vehicle is started. In such case the signal can thus be considered a signal representing a starting of the vehicle. The signal is for example a start-engine signal or an ignition signal. For example, the vehicle is started by turning the key in the ignition. For example, the vehicle is started by pressing a start-button in presence of the key, i.e. the so called keyless start. Starting the vehicle may cause that auxiliary loads require energy. For example, the HVAC system starts to operate, external and/or internal lights are switched on, audio system starts to play, etc.

Additionally, the method according to the invention may further comprise a step 44 of arranging a current sensor at the low voltage terminal of the first converter The additional step 44 of the method is indicated by dashed lines in FIG. 5. The current sensor is configured to determine an output current at the low voltage terminal of the first converter. For example, the current sensor may be a clamp sensor or a hall effect sensor, e.g. a split core hall effect sensor. The current sensor is configured to operate at a bandwidth of at least 1 kHz, preferably above 1 kHz, more preferably above 2 kHz.

The control unit is configured to control the second converter based on the determined output current by the current sensor. The current sensor may e.g. transmit a current signal representing the determined output current to the control unit to control the second converter. The control unit controls the second converter to supply a current to the low voltage bus so as to reduce the determined output current. For example, the output current of the first converter is reduced below 0.5 A, preferably below 0.2 A, more preferably to 0 A, when the current sensor determines the output current at the low voltage terminal of the first converter.

The reduction of the output current at the low voltage terminal of the first converter enables the power source integration to the low voltage side of any EV without the prior knowledge of the EV specific first converter control algorithm. Therefore, no support from the EV manufacturer is needed.

Additionally, the method according to the invention may further comprise a step 45 of connecting an additional battery to a battery terminal of the second converter. The additional step 45 of the method is indicated by dashed lines in FIG. 5. The additional battery is configured to store power generated by the power source. The additional battery may be configured to store power generated by the power source, e.g. a PV unit or a hydrogen cell. The additional battery may e.g. be a solar battery which is configured to store solar power from a PV unit comprising at least one solar panel. The additional battery may e.g. be a Li-ion battery. The control unit is configured to control a power flow of the second converter from power source and/or the additional battery to the low voltage bus.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage. The term coupled, as used herein, is defined as connected, although not necessarily directly, and not necessarily mechanically.

A single processor or other unit may fulfil the functions of several items recited in the claims.

1. Power A power system for an electric vehicle comprising;
a high voltage bus for delivering energy to parts operating at a high voltage, wherein the high voltage bus is connectable to a high voltage battery,
a low voltage bus for delivering energy to auxiliary loads operating at a low voltage, wherein the low voltage bus is connectable to a low voltage battery,
a first converter having
a high voltage terminal configured to be connected to the high voltage bus, and
a low voltage terminal configured to be connected to the low voltage bus,
a second converter having
a power terminal configured to be connected to a power source, and
a low voltage terminal configured to be connected to the low voltage bus,
a control unit configured to
receive a signal representative of an energy demand of the auxiliary loads, and
control the second converter based on the received signal, whereby the control unit is configured to control the second converter to supply a current to the low voltage bus.

2. The power system according to claim 1, wherein the signal represents an unlocking of the vehicle.

3. The power system according to claim 1, wherein the signal represents a starting of the vehicle.

4. The power system according to claim 1, wherein the power system further comprises the power source.

5. The power system according to claim 1, wherein the power source is a PV unit comprising at least one solar panel.

6. The power system according to claim 1, wherein the power system further comprises an additional battery arranged at a battery terminal of the second converter, wherein the additional battery is configured to store power generated by the power source.

7. The power system according to claim 6, wherein the control unit is configured to supply the current to the low voltage bus by controlling a power flow of the second converter from the power source and/or the additional battery to the low voltage bus.

8. The power system according to claim 6, wherein the control unit is configured to supply the power generated by the power source to the additional battery by controlling a power flow of the second converter from the power source to the additional battery.

9. The power system according to claim 1, wherein the power system further comprises a current sensor configured to determine an output current at the low voltage terminal of the first converter, wherein the control unit is configured to control the second converter based on the determined output current, whereby the control unit is configured to control the second converter to supply the current to the low voltage bus so as to reduce the determined output current.

10. The power system according to claim 9, wherein the current sensor is arranged at the low voltage terminal of the first converter.

11. The power system according to claim 9, wherein the current sensor is a hall effect sensor.

12. The power system according to claim 9, wherein the current sensor is a split core hall effect sensor.

13. The power system according to claim 9, wherein the current sensor is a clamp current sensor.

14. The power system according to claim 1, wherein the control unit comprises a hysteresis controller configured to control the current supply of the second converter, wherein the hysteresis controller is configured to
increase the current supply of the second converter to the low voltage bus when the determined output current at the low voltage terminal of the first converter becomes higher than a hysteresis range,
decrease the current supply of the second converter to the low voltage bus when the determined output current at the low voltage terminal of the first converter becomes lower than the hysteresis range.

15. The power system according to claim 14, wherein the hysteresis range is between 0.5 A-10 A, preferably between 0.5 A-8 A, more preferably between 0.5 A-5 A.

16. The power system according to claim 9, wherein the current sensor is operating at a bandwidth of at least 1 kHz, preferably above 1 kHz, more preferably above 2 kHz.

17. The power system according to claim 1, wherein the first converter is a unidirectional converter configured to transfer power from the high voltage battery and the low voltage battery.

18. The power system according to claim 1, wherein the second converter is a three-port DC/DC converter.

19. The power system according to claim 1, wherein the low voltage battery is a lead acid battery or a lithium-ion battery.

20. The power system according to claim 9, wherein the output current of the first converter is reduced below 0.5 A, preferably below 0.2 A, preferably to 0 A, when the current sensor determines the output current at the low voltage terminal of the first converter.

21. The power system according to claim 1, wherein the power source is integrated in the roof of the electrical vehicle.

22. The power system according to claim 1, wherein the low voltage battery operates in a range of 12-48 volts, preferably 12 volts and the high voltage battery operates above 60 volts, preferably between 200-600 volts, more preferably between 300 volts and 450 volts.

23. A method of integrating a power source to an electric vehicle, the electric vehicle comprising:
a high voltage bus for delivering energy to parts operating at a high voltage, wherein the high voltage bus is connectable to a high voltage battery,
a low voltage bus for delivering energy to auxiliary loads operating at a low voltage, wherein the low voltage bus is connectable to a low voltage battery,
a first converter configured to connect the high voltage bus arranged at a high voltage terminal of the first converter to the low voltage bus arranged at a low voltage terminal of the first converter,
the method comprising the steps of:
connecting a second converter to the low voltage bus, wherein the low voltage bus is arranged at a low voltage terminal of the second converter,
mounting the power source to the electric vehicle,
connecting the power source to a power terminal of the second converter,
providing a control unit configured to
receive a signal representative of energy demand of the auxiliary loads, and
control the second converter based on the received signal, whereby the control unit is configured to control the second converter to supply a current to the low voltage bus.

24. The method according to claim 23, wherein the method further comprises the step of generating the signal when the electric vehicle is unlocked.

25. The method according to claim 23, wherein the method further comprises the step of generating the signal when the electric vehicle is started.

26. The method according to claim 23, wherein the method further comprises the step of
arranging a current sensor at the low voltage terminal of the first converter, wherein the current sensor is configured to determine an output current at the low voltage terminal of the first converter, and wherein the control unit is configured to control the second converter based on the determined output current, whereby the control unit is configured to control the second converter to supply the current to the low voltage bus so as to reduce the determined output current.

27. The method according to claim 23, wherein the method further comprises the step of connecting an additional battery to a battery terminal of the second converter, wherein the additional battery is configured to store power generated by the power source.

28. The method according to claim 26, wherein the current sensor is configured to transmit the determined output current to a control unit to control the second converter.

29. The method according to claim 26, wherein the output current of the first converter is reduced below 0.5 A, preferably below 0.2 A, preferably to 0 A, when the sensor determines the output current at the output terminal of the first converter.

30. The method according to claim 23, wherein the power source is mounted in the roof of the electric vehicle.

31. The method according to claim 23, wherein the low voltage battery operates in a range of 12-48 volts, preferably 12 volts and the high voltage battery operates above 60 volts, preferably between 200-600 volts, more preferably between 300 volts and 450 volts.

32. A kit for an electric vehicle, the electric vehicle comprising:
a high voltage bus for delivering energy to parts operating at a high voltage, wherein the high voltage bus is connectable to a high voltage battery,
a low voltage bus for delivering energy to auxiliary loads operating at a low voltage, wherein the low voltage bus is connectable to a low voltage battery,
a first converter having
a high voltage terminal configured to be connected to the high voltage bus, and
a low voltage terminal configured to be connected to the low voltage bus, the kit comprising:
a second converter having
a power terminal configured to be connected to a power source, and
a low voltage terminal configured to be connected to the low voltage bus,
a current sensor configured to determine an output current at the low voltage terminal of the first converter,
a control unit controlling the second converter based on the determined output current, whereby the control unit is configured to control the second converter to supply a current to the low voltage bus so as to reduce the determined output current.
